(19) United States
(12) Patent Application Publication
(10) Pub. No.: US 2006/0190262 A1
(43) Pub. Date: Aug. 24, 2006

(54) Voice recognition system and method for tactical response

(75) Inventor: Michael Roskind, Woodinville, WA (US)

Correspondence Address: PROCOPIO, CORY, HARGREAVES & SAVITCH LLP, 530 B STREET, SUITE 2100, SAN DIEGO, CA, 92101, US

(73) Assignee: High Technology Solutions, Inc.

(21) Appl. No.: 10/752,172

(22) Filed: Jan. 6, 2004

(51) Int. Cl. G10L 21/00

(52) U.S. Cl. 704/270

(57) ABSTRACT

A system and method for an officer in the field to safely, efficiently, and quickly run license plate numbers and collect license plate numbers is provided. A central precinct server maintains a database of license plate numbers, including plate numbers associated with specific instances and plate numbers of interest (e.g., stolen vehicle plate numbers). Periodically, a patrol car computer is provided with a list of the plate number of interest (“hotsheet”) so that the patrol car computer is synchronized with the precinct hotsheet. The patrol car computer is configured with an audio data entry means that allows an officer can speak license plate numbers into the patrol car computer. The spoken plate numbers are translated into text by the patrol car computer and the text plate numbers are then used to query the patrol car computer hotsheet to determine the status of the license plate number. The status can be displayed on the screen of the patrol car computer or indicated by an audio alert. Additionally, as an officer responds to an incident, the officer can speak license plate numbers into the audio data entry means and those spoken plate numbers are translated into text and stored. All of the license plate numbers spoken by the officer while responding to the incident are collected together and associated with an incident number for the particular event. These license plate numbers are later uploaded to the central precinct computer for collation with other collections of license plate numbers for the particular incident in order to create a comprehensive database for the incident and also to identify license plate numbers that were spotted at similar types of incidents.

### BACKGROUND

1. Field of the Invention

The present invention generally relates to the fields of voice recognition and telemetry and more specifically relates to the acquisition and use of law enforcement data by officers and mobile units deployed in the field.

2. Related Art

The single most common function in a patrol car is the running of license plates for stolen vehicles and warrants. This activity is repeated over one million times each day. Conventionally, running a license plate requires the responding officer to radio a central precinct or other location where the license plate check is performed. The results of the license plate check are then radioed back to the officer.

In order to reduce the radio communications associated with running license plates to check for stolen vehicles, most jurisdictions have developed a paper hot sheet, which is a list of license plates for stolen vehicles and vehicles for which the owner has a warrant. Although cumbersome, and even dangerous if an officer is driving a vehicle, these single jurisdictional hot sheets allow the officer to check the license plate number of a vehicle without breaking radio silence. In some instances, unfortunately, tactical procedural requirements require radio silence for example, when an officer is responding to an event. A significant drawback of the paper hotsheet is that they are ineffective when an officer is in pursuit or nearing the scene of an event.

For example, a patrol vehicle responding to a major event with an unknown suspect or vehicle has the greatest need to check plates as the officer drives towards the crisis site. Ironically, procedural tactics often preclude the use of a radio voice channel for this purpose. Furthermore, as multiple officers react to the event, the voice radio frequency typically becomes closed to checking plates to allow for the tactical placement and coordination of responders by a central command. Therefore, any transmission except for emergency traffic is excluded.

Therefore, what is needed is a system and method for use in the field that allows license plate numbers to be collected and checked while an officer is responding to an event without breaking radio silence on the voice channel.

### SUMMARY

Accordingly, the present invention provides a system and method for an officer in the field to safely, efficiently, and quickly collect license plate number when responding to an event and also to safely, efficiently, and quickly run license plate numbers to check the status of the vehicle. To implement the system and method, a central precinct server maintains a data storage area that includes a plurality of data collections, including an updated hotsheet. Periodically, a patrol car computer is provided with the complete hotsheet or updates so that the patrol car computer is synchronized with the precinct hotsheet. The patrol car computer is configured with an audio data entry means so that an officer can speak license plate numbers into the patrol car computer and those spoken plate numbers can be translated into text. The text plate numbers are then used as a query to the patrol car computer hotsheet and the status of the plate can be displayed on the screen of the patrol car computer or indicated by an audio alert.

Additionally, as an officer responds to an incident, the officer can speak license plate numbers into the patrol car computer and those spoken plate numbers can be translated into text and stored. All of the license plate numbers spoken by the officer during the response to the incident are collected together and assigned to an incident number for the particular event. These license plate numbers are later uploaded to the central precinct computer for collation with other collections of license plate numbers for the particular incident in order to create a comprehensive database for the incident and also to identify license plate numbers that were spotted at similar types of incidents.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a high level network diagram illustrating an example voice recognition tactical response system according to an embodiment of the present invention;

FIG. 2 is a block diagram illustrating an example mobile computer according to an embodiment of the present invention;

FIG. 3 is a block diagram illustrating an example display presentation for a license plate status according to an embodiment of the present invention;

FIG. 4 is a flow diagram illustrating an example process for initializing a local hotsheet according to an embodiment of the present invention;

FIG. 5 is a flow diagram illustrating an example process for wireless synchronization of a mobile device according to an embodiment of the present invention;

FIG. 6 is a flow diagram illustrating an example process for querying a local hotsheet with a voice command according to an embodiment of the present invention;

FIG. 7 is a flow diagram illustrating an example process for creating an incident list with voice commands according to an embodiment of the present invention;

FIG. 8 is a flow diagram illustrating an example process for collating incident lists according to an embodiment of the present invention;

FIG. 9 is a block diagram illustrating an exemplary wireless communication device that may be used in connection with the various embodiments described herein; and

FIG. 10 is a block diagram illustrating an exemplary computer system as may be used in connection with various embodiments described herein.

### DETAILED DESCRIPTION

Certain embodiments as disclosed herein provide for systems and methods for voice recognition in tactical response situations. Additionally disclosed are systems and methods for creating license plate lists associated with discrete incidents and combining incident lists to identify witnesses and suspects. For example, one method as disclosed herein allows an officer responding to an event to speak license plate numbers of cars encountered in the vicinity of the event into an onboard computer. Those plate numbers are converted to text and associated with an incident number and then later collated with other lists for the same incident number to develop a comprehensive potential suspect and witness list. Additionally, an officer can speak license plate numbers into the on board computer to determine the status of the vehicle while maintaining radio silence.

After reading this description it Will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

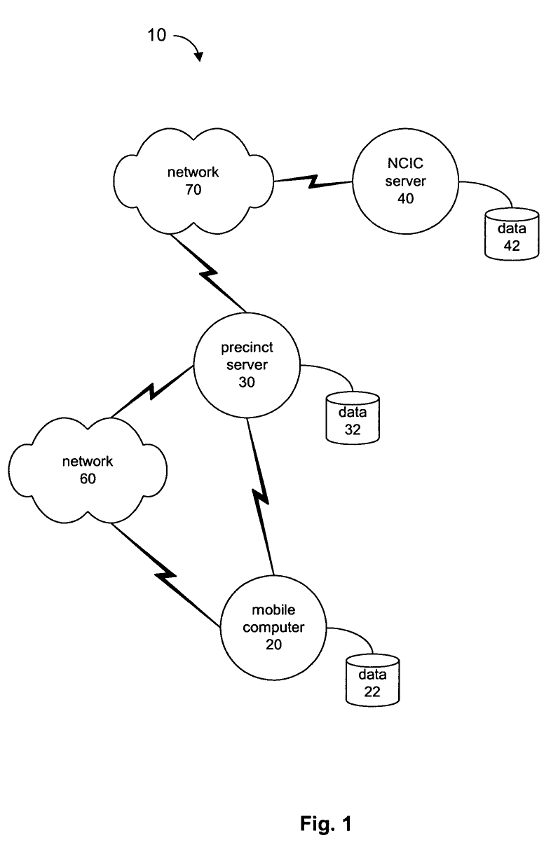

FIG. 1 is a high level network diagram illustrating an example voice recognition tactical response system 10 according to an embodiment of the present invention. In the illustrated embodiment, the system 10 comprises a mobile computer 20 coupled with a data storage area 22. The mobile computer 20 is communicatively linked with a precinct server 30 that is similarly coupled with a data storage area 32. The mobile computer 20 and precinct server 30 can be linked via a direct connection or portable storage medium or via a network such as network 40.

The system 10 also comprises an NCIC server 40 that is coupled with a data storage area 42. Preferably, the NCIC server 40 is communicatively linked with the precinct server via a network 60. In one embodiment, the NCIC server stores a national list of vehicle plates and status in an NCIC database. State or other local jurisdictional lists may also be stored in the NCIC database or other database servers managing information about vehicle status, such as a state or county database server. The NCIC database (and possibly other similar databases) is preferably periodically downloaded by the precinct server 30 so that the local copy of the database is kept in synch with the national, state, or regional database(s). The local copy is preferably stored in the data storage area 32.

Additionally, other information may also be stored in the data storage area 32. For example, information that is manually entered by a dispatcher or an operator at a teletype machine may be stored in data storage area 32. This information may also be merged into the local copy of the database. Thus, the local precinct server 30 preferably maintains an updated database that combines various other databases and locally captured data into a single database. Additionally, the locally captured information such as incident lists can be provided to the NCIC server 40 or other national database servers to facilitate interstate and intrastate operability.

In one embodiment, the local copy of the raw vehicle status database downloaded from the NCIC server 40 can be filtered to reduce the size of the database. For example, the raw database may contain information about the owner of the vehicle, make, model, color, and other ancillary information about the vehicle or owner. To reduce the total size of the database, the filtered database may include only the license plate number and status information.

The status information may include, for example, stolen, warrant, missing person, or other potential types of vehicle status. Additionally, the various types of vehicle status may be represented by a variable or moniker such that the size of the database is further reduced without limiting the amount of information. For example, the stolen status may be represented by the letter A, while the warrant status may be represented by the letter B and so on. Those skilled in the art will recognize this and other ways to condense or compress the data in the streamlined database.

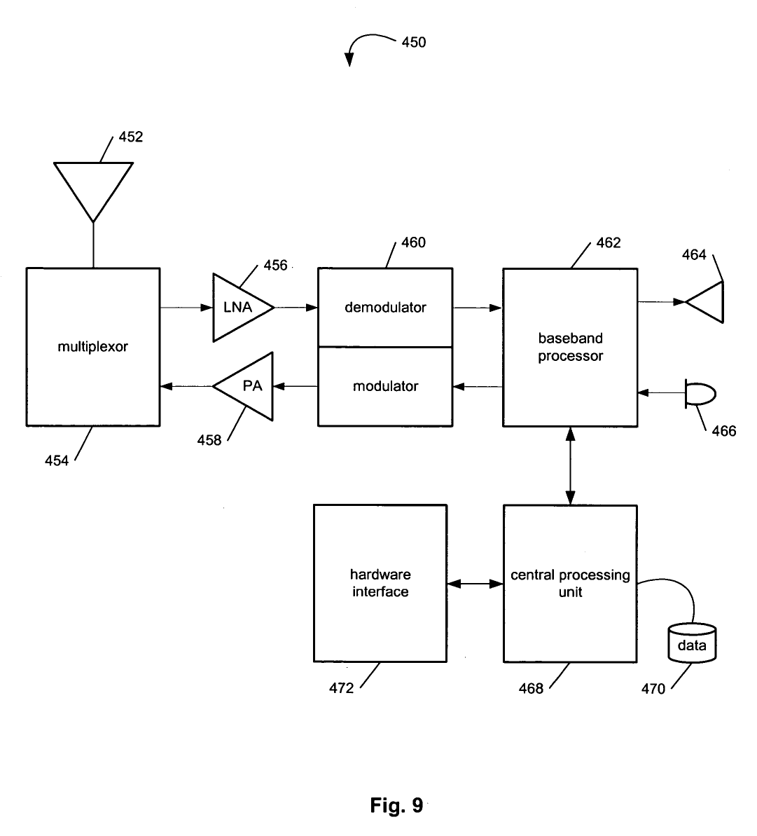

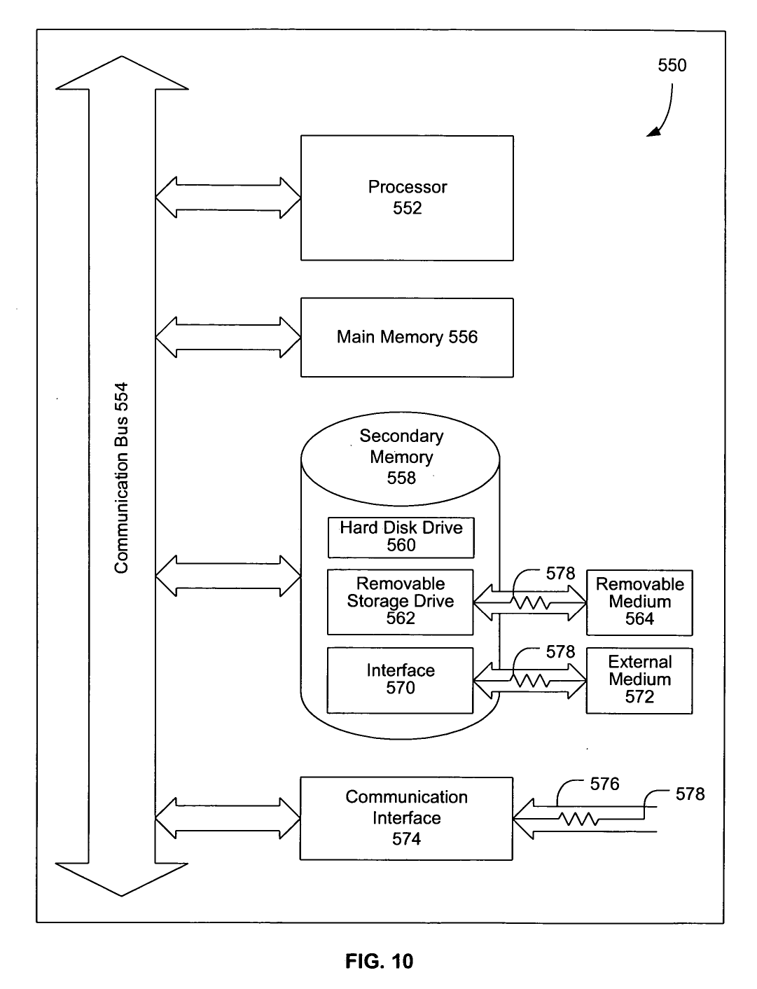

Mobile computer 20 can be any of a variety of types of computer systems, including a laptop computer, a personal digital assistant (“PDA”), a tablet PC, an integrated vehicle computer, or a cellular telephone, just to name a few. Alternative types of wireless communication devices and computer systems that can be employed as mobile computer 20 are later described with respect to FIGS. 9 and 10.

The mobile computer 20 can be communicatively linked with the precinct server 30 via a direct link such as a physical cable or a docking station. The direct link may also be implemented as a direct wireless connection such as an infrared (“IR”) link or a bluetooth link. Alternatively, the mobile computer 20 can be communicatively linked with the precinct server 30 via a communication network 50. The network 50 can be a local area network (“LAN”), wide area network (“WAN”), or other type of public or private network. Additionally, network 50 can be a wired or wireless network.

Preferably, the direct or network link between the mobile computer 20 and the precinct server 30 facilitates the transfer of data between the two computer devices. For example, the filtered database is preferably transferred to the mobile computer 20 from the precinct server 30 via the direct or network communication link. In one embodiment, the network 50 serves as the communication link and network 50 is a wireless wide area network (“WWAN”) that allows the mobile computer 20 to be in persistent network communication with the precinct server and receive or request updates from the precinct server 30 in real time.

The communication link between the precinct server 30 and the mobile computer 20 may also be effected by a data storage medium such as a floppy disk, compact disk, universal serial bus (“USB”) drive, or other portable storage medium.

In one embodiment, network 60 may be a single network or a combination of networks such as the internet. Preferably, network 60 links the precinct server to one or more source servers such as NCIC server 40. In one embodiment, there are a plurality of source servers that each represent a different jurisdiction or combination of jurisdictions and those source servers provide raw vehicle status databases to the precinct server for download or query.

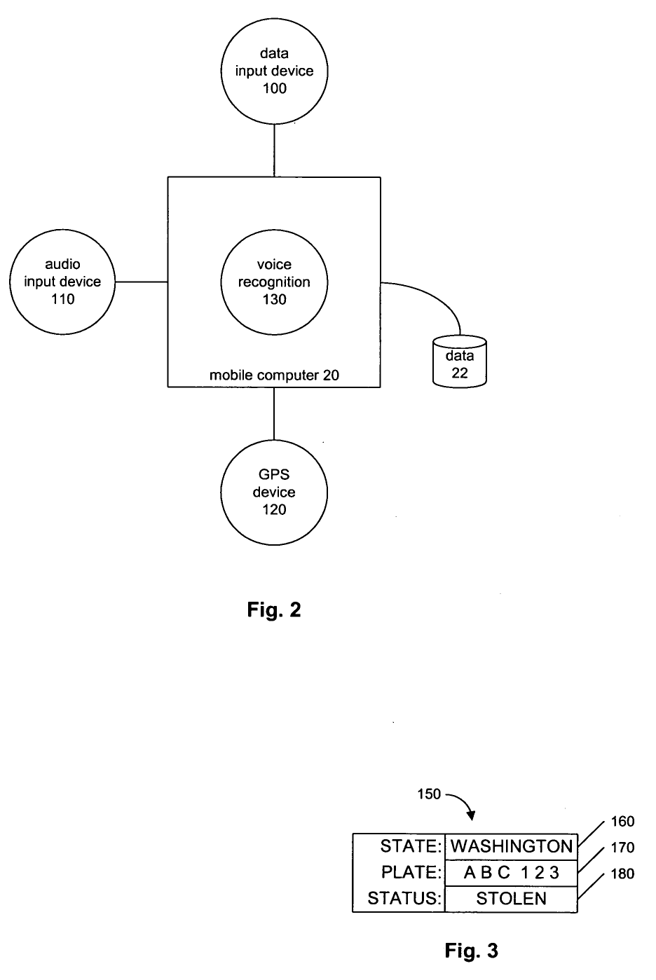

FIG. 2 is a block diagram illustrating an example mobile computer 20 according to an embodiment of the present invention. In the illustrated embodiment, the mobile computer 20 comprises a data input device 100, an audio input device 110, a global positioning service (“GPS”) device 120, a voice recognition module 130, and a data storage area 22. Although not shown in the illustrated embodiment, the mobile computer 20 can also be equipped with a network interface that allows the computer 20 to connect to a wired or wireless data network. In an alternative embodiment, the computer 20 may also be configured with a network interface that allows it to establish a circuit connection for voice communications over a wireless communication network (also not pictured).

The data input device 100 can be a floppy disk drive or a compact disk drive. Alternatively, the data input device 100 can be a USB drive, fire wire connector or other type of drive that conforms to a communication standard for transferring data from a storage or computer device to another storage or computer device. In one embodiment, the data input device is a conventional floppy disk drive and the mobile computer 20 is a mobile laptop computer that can be mounted in a patrol vehicle.

The audio input device 110 can be any type of microphone device that is electrically coupled with the mobile computer 20. In one embodiment, the audio input device 110 receives analog audio signals and converts them to digital signals and provides those digital signals to the mobile computer 20. Alternatively, the audio input device 110 may provide analog audio signals to the mobile computer 20 where the signals are then converted to digital signals. Preferably, the function of the audio input device 110 is to receive spoken commands or words from an operator of the mobile computer 20 and provide those audio commands or words to the mobile computer 20. In one embodiment, the audio input device 110 is a microphone mounted to a boom and configured for placement near the mouth of the operator such that voice commands and words can be detected and captured in a high noise environment.

The GPS device 120 is preferably a GPS capable receiver that can detect signals from a GPS beacon or satellite (or both) and thereby calculate the position of the mobile computer 20. GPS location devices are well known in the art and will therefore not be described in detail. The function of the GPS device 120 is to capture the location of the mobile computer 20 in accordance with voice or text data entry and associate the data entry with the location of the mobile computer 20 at the time the data was entered into the mobile computer 20.

In one embodiment, the GPS device may also provide the location information to a mapping system configured to display the license plate number or other indicator of the vehicle on a map. Advantageously, the map showing the location of the vehicle and preferably the license plate number can be shared with a central command or other vehicles in the proximity or involved in and attempt to stop or follow the vehicle. Thus, the GPS location information can be shared with other vehicles directly or through a central command and control, in association with the voice recognition system and the capture of a license plate number at a particular location.

The voice recognition module 130 can be implemented as a software module or a hardware device such as a special application specific integrated circuit (“ASIC”). The function of the voice recognition module 130 is to receive audio input from the audio input device 110 and convert that input into text. Voice recognition module 130 is also preferably configured to store the resulting text in the data storage area.

In one embodiment, voice recognition module 130 is additionally configured with various data management capabilities. For example, the module 130 can be configured to accept a plurality of voice data entry blocks and convert those blocks into text and then store those blocks of converted text in an associated group. The voice recognition module 130 may also assign a specific incident number to the group. In one embodiment, an operator of the mobile computer 20 may sequentially speak a series of license plate numbers into the audio input device 110. Preferably, the voice recognition module 130 converts the audio plate numbers to text plate numbers and stores all of the sequentially spoken plate numbers in the data storage area 22, for example in a single file. Additionally, the file may be saved in the data storage area 22 with the file name being an incident number. The incident number may be provided to the mobile computer 20 by similar voice command and text conversion by the voice recognition module 130.

The data storage area 22 preferably comprises both a volatile storage area and a persistent storage area. In one embodiment, a sequence of voice data received by the mobile computer 20 can be stored in volatile storage until the voice data entry and conversion is complete. Then the converted voice data can be stored in persistent storage, for example as a file with a plurality of text entries.

FIG. 3 is a block diagram illustrating an example display presentation 150 for a license plate status according to an embodiment of the present invention. In the illustrated embodiment, the information shown for a particular plate comprises the state 160, the plate number 170, and the status 180. Additional information may also be provided. In one embodiment, the status information may include STOLEN, WARRANT, MISSING PERSON, and CLEAR, just to name a few. Additional status identifiers may also be used where appropriate.

In use, the display presentation 150 may be complemented by a perceptible audio alert that signals a particular status or audibly discloses the status. For example, there may be an audio alert only for the status STOLEN. Alternatively, each status may have a different audio alert so that the operator does not have to view the display presentation 150 to know what the status of the vehicle is. In yet another alternative, the audio alert may be associated with any status that is not CLEAR so that the operator is made aware of the need to pursue or stop the vehicle. In one embodiment, the status identifier may be presented with a different color, type, or style of font, or alternatively a different color or blinking background to call attention to a particular status.

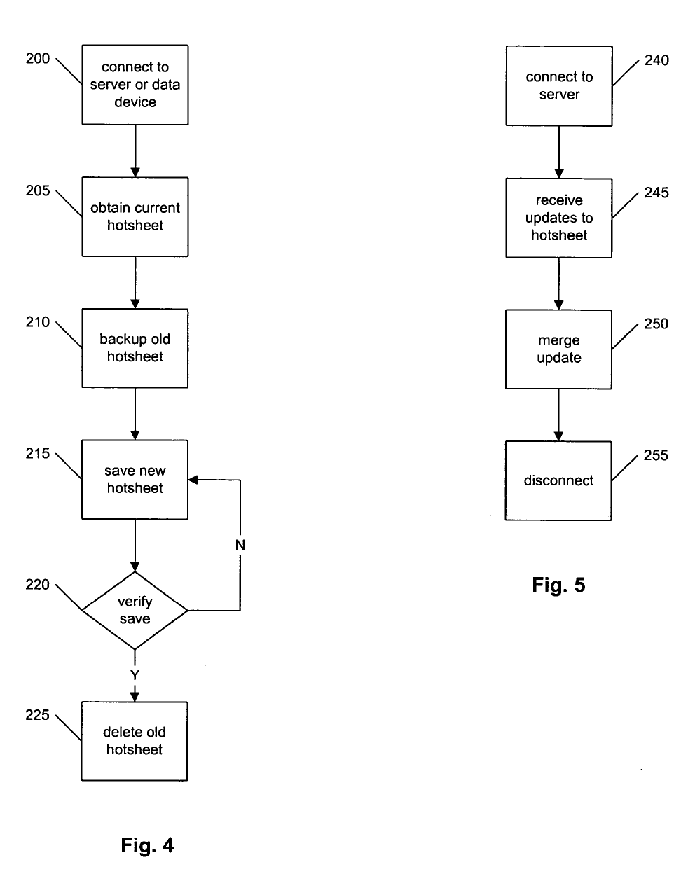

FIG. 4 is a flow diagram illustrating an example process for initializing a local hotsheet according to an embodiment of the present invention. Initially, in step 200, the mobile computer connects to the server or other data device. In one embodiment, the connection may be made with a network, for example, a wireless network or a wired network. The network connection may be made via a file transfer utility or a custom hotsheet application dedicated to initializing or synchronizing a local hotsheet. Alternatively, the connection can be made indirectly through a data storage medium that contains the hotsheet. In such a connection to a data device, placing a floppy disk or a compact disk or other portable storage medium in an appropriate drive on the mobile computer preferably makes the connection. Preferably, the connection step facilitates access to the actual hotsheet data. In one embodiment the mobile computer connects to the server via a wireless communication network. In an alternative embodiment, the mobile computer connects to the server via a wired network.

Once the mobile computer has connected to the server or the data device containing the hotsheet, the mobile computer obtains a copy of the hotsheet, as illustrated in step 205. The hotsheet may be obtained by a simple file transfer program or a more sophisticated database merge utility. In the simple case, the new hotsheet can be copied from the source (server computer or data device) to a location in volatile or persistent storage on the mobile computer. In the more sophisticated embodiment, each entry in the hotsheet may be merged into an empty hotsheet on the mobile computer, the result of which is ultimately a complete download of the hotsheet. Such a download may be temporarily stored in volatile storage and upon completion, transferred to persistent storage.

Preferably, the version of the hotsheet that is obtained by the mobile computer is the most current version maintained by the server. Additionally, the version of the hotsheet obtained by the mobile computer is preferably optimized for size. For example, the complete hotsheet is preferably filtered to limit the amount of information provided for each license plate number to only that information that is necessary. In one embodiment, the hotsheet file can be limited to license plate number, state of registration, and status.

After obtaining the hotsheet from the server or the data device, in step 210 the mobile computer performs a backup of any existing hotsheet so that if the new hotsheet data acquisition step failed, that the system will at a minimum have the most recent hotsheet information. Next the new hotsheet is saved from volatile storage into permanent storage, as shown in step 215 and the new hotsheet is validated in step 220 to ensure that the transfer and save process completed successfully. If the verification step 220 indicates that the new hotsheet is not valid, then the process may return to the save step and re-save the hotsheet to determine if the save process failed or if the transfer process resulted in a corrupt hotsheet file.

Alternatively, the mobile computer may attempt to validate the hotsheet that is stored in volatile memory for the same purpose. If the hotsheet validation is successful, then the mobile computer can delete the backed up version of the hotsheet and the version of the new hotsheet in volatile memory, as illustrated in step 225. If the hotsheet validation fails and iterations through re-saving or validating the data in volatile memory also fail, then the backed up version of the hotsheet may be reinstated.

FIG. 5 is a flow diagram illustrating an example process for wireless synchronization of a mobile device according to an embodiment of the present invention. Initially, in step 240, the mobile computer connects to the precinct server via a wireless communication network. Preferably, the connection is made as a data connection to facilitate efficient download of updates to the local hotsheet or other advantageous data collections such as a list of all points bulletins (“APBs”) or the like. Although data can be transmitted via a voice connects, for example in simple message system (“SMS”) packets, the system preferably establishes a data connection in step 240.

Next, in step 245, the mobile computer receives an update to the hotsheet. The receipt of the update may be prompted by an automatic command sent by the mobile computer. Alternatively, the handshaking process during the connection step may cause the server computer to initiate the download of the hotsheet, for example in response to detecting an authorized connection. Once the hotsheet download is complete, the mobile computer preferably merges the update into the existing local hotsheet, as illustrated in step 250. Once the hotsheet update has been merged in with the existing hotsheet and validated, then the mobile computer can disconnect from the server computer, as shown in step 255. In an alternative embodiment, the mobile computer may disconnect upon completion of the download in order to more efficiently use the bandwidth of the wireless data network.

Additionally, before, during, or after the download process, the mobile computer may also upload data to the server computer making the transaction a two-way data exchange. For example, queries to a database managed by the precinct server may be uploaded. Alternatively, queries to other databases or remote databases may be uploaded to the precinct server for later execution or distribution to the remote server. Examples of data that may be uploaded includes incident lists, witness lists, GPS information, and other helpful data collected by a field deployed officer, vehicle, or mobile computer.

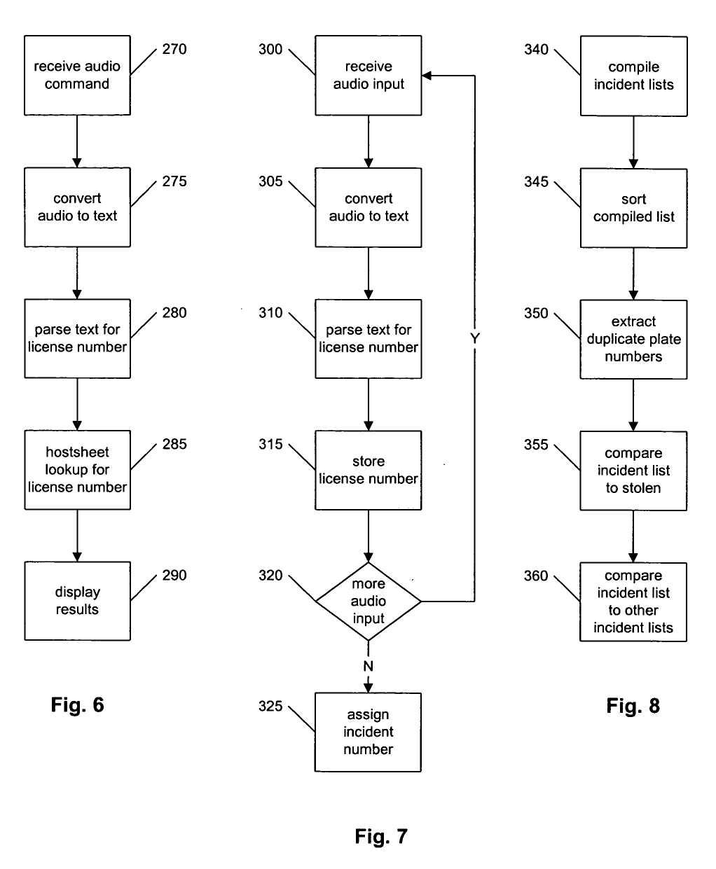

FIG. 6 is a flow diagram illustrating an example process for querying a local hotsheet with a voice command according to an embodiment of the present invention. Initially, in step 270, the mobile computer receives an audio command. The audio command is preferably spoken into an audio input device and can be converted from a native analog signal to a digital signal. After receiving the audio command, in step 275 the mobile computer converts the audio command to a string of text. In one embodiment, a voice recognition module (hardware or software or some combination of the two) handles the conversion of the audio input to text data. Preferably, the universe of voice commands is pre-defined to facilitate fast, efficient, and accurate translations. For example, if the voice command is a license plate number, the universe of voice commands may comprise a state, the letters of the alphabet, and the numbers 0-9.

After converting the audio input to text, the mobile computer parses the text to identify the license plate number, as shown in step 280. In one embodiment, the various components of the license plate number may be individually obtained and populated into a temporary data structure in memory. For example, the state indicator may be placed in a state designator field while the plate number is placed in a plate number field.

Alternatively, the audio input may comprise several license plate numbers spoken in sequence. In such an embodiment, the conversion of audio to text may take place over time as more plate numbers are input in audio format. When converting that type of audio input to text, the conversion process may place blanks or other whitespace or delimiting characters in the text to indicate a time lapse in the audio input. Thus, the parsing step may look to whitespace or other delimiting character to aid in the parsing of a discrete license plate number from a sequence of license plate numbers.

In step 285, the mobile computer compares the newly input license plate number to the plate numbers in the hotsheet. In step 290, if the plate number is found, the status of the vehicle is presented on the display of the mobile computer or an audio alert may be sounded. In some cases, both a visual and audio presentation of the status may be employed. Alternatively, if the plate number is not found in the hotsheet, the vehicle status is still preferably provided on the display of the mobile computer, however the status of the vehicle may be shown as CLEAR or an audio alert indicating CLEAR may be sounded, or both.

A significant advantage of this process for running plates is that it allows the operator of the mobile computer to keep his or her eyes focused on surroundings rather than focused on a computer display. Therefore, more license plate numbers can be checked in a shorter period of time. Additionally, the safety of an operator who is driving a vehicle, motorcycle, or bicycle is significantly increased by not having to look at the mobile computer.

FIG. 7 is a flow diagram illustrating an example process for creating an incident list with voice commands according to an embodiment of the present invention. Initially, in step 300, the mobile computer receives an audio input. For example, the audio input can be spoken into an audio input device by an operator of the mobile computer: In one embodiment, the operator speaks a series of license plate numbers into the audio input device in a sequential fashion. Preferably, an audio delimiter or period of pause can be used to separate discrete license plate numbers. Once the audio input in received, it can be converted from its native analog format to a digital format to facilitate conversion to text and processing.

After receiving the audio input, the mobile computer converts the audio input to a string of text, as illustrated in step 305. In one embodiment, a hardware or software implemented voice recognition module handles the conversion of the audio input to text data. As previously described, the universe of voice commands is preferably pre-defined to facilitate fast, efficient, and accurate translations. For example, if the voice command is a license plate number, the universe of voice commands may comprise a state, the letters of the alphabet, and the numbers 0-9.

Once the audio input is converted to text, in step 310 the mobile computer parses the text to identify the license plate number. In one embodiment, the beginning of a discrete license plate number may be identified by locating a state indicator. In such a fashion, a complete license plate number may be identified as the text between the beginning of a first state indicator and the beginning of a second state indicator. Alternatively, a specific audio delimiter may be employed such that the conversion of the audio input may result in a text string with the word NEXT between each discrete license plate number.

Once a discrete license plate number is identified, it is stored in volatile or persistent memory, as shown in step 315. In an alternative embodiment, more information may be also be stored with the plate number. For example, if the operator provides additional information about the vehicle such as the color, make, model, associate house number, or a description of the driver, this information may also be collected and stored along with the license plate number.

Additional information that may be advantageously collected and stored with the license plate number includes location information. For example, the mobile computer maybe configured with a GPS location capability. Thus, as the mobile computer receives audio input and converts that input to text and parses a discrete license plate number from the text, the mobile computer may also be tracking its precise GPS location. In step 315, when the license plate number is stored, it may be stored in connection with the GPS location where the plate number was spotted or entered by the operator. Advantageously, the time of the entry may also be associated with the plate number and the GPS location.

Once the plate number has been stored, by itself or in combination with location information, if more audio input is available, as determined in step 320, then the process loops back and receives that input and process it in the same fashion until all of the discrete license plate numbers are stored. In one embodiment, the various license plate numbers may be populated into a temporary data structure in volatile memory. After determining in step 320 that no more audio input is available, the temporary data structure may be stored in persistent memory on the mobile computer. For example, the temporary data structure may be a file with each discrete license plate number entered on a separate line in the file. Alternatively, each discrete license plate number may be separate by a delimiting character such as the vertical bar “|” character.

Finally, the collection of license plate numbers are assigned to an incident number. In one embodiment, each line of the file may have a discrete license plate number and the incident number, e.g., separated by a delimiting character. Alternatively, each incident number may have a separate file, with the name of the file being the incident number. Thus, file number OC-12345 contains those license plate numbers assigned to incident number OC-12345. Alternative methods may be employed to associate license plate numbers with incident numbers, as will be understood by those having skill in the art. The function of the assignment is to allow later compilation of a plurality of collections of license plate numbers for the same incident, for example at the precinct server.

A significant advantage of this process for creating an incident list of plate numbers is that it allows the operator of the mobile computer to keep his or her eyes focused on surroundings rather than focused on a computer display. Therefore, more license plate numbers can be collected as the operator patrols the- vicinity of an event. Additionally, the operator does not need to break radio silence to collect the plate numbers and if a wireless data network connection is available, the incident list can be uploaded to the precinct server in real time without interfering with the voice radio channel. This can be extremely advantageous if the plate numbers in the incident list can be compared to historical lists of plate numbers for similar types of incidents and any plate numbers of particular interest can be communicated back to the responding officers via the data channel or over the voice radio channel.

FIG. 8 is a flow diagram illustrating an example process for collating incident lists according to an embodiment of the present invention. Initially, in step 340, the precinct server compiles two or more incident lists together. For example, the incident lists may be received as separate files, with each file having the same name. Alternatively, the prefix of the file names may all be the same, with a suffix added by the server upon receipt to indicate who or where the incident list was received from or in what order the incident list was received. In step 340, the various incident lists can all be concatenated together into a single list or otherwise appended to each other or compiled together. In one embodiment, compiling the lists together may be achieved by reading all of the lists associated with a single incident number into temporary storage in volatile memory.

Once the various incident lists associated with a particular event are compiled together, the resulting list is sorted in step 345. An advantage of sorting the list is that the sorted list facilitates identification of duplicate plate numbers in the list. For example, two patrol officers may have spotted a moving vehicle near an event and each officer may have recorded the plate number. Thus, the plate number would appear twice in the same incident list. Duplicate plate numbers are extracted in step 350.

In step 355, the resulting incident list of license plates is compared to a list of stolen vehicle plates to identify what vehicles spotted near the event were stolen. In one embodiment, stolen vehicles may be reported back to the responding officers via the radio channel or as an update to the mobile computer's hotsheet. Additionally, in step 360, the resulting incident list is compared to other incident lists to determine if any license plate numbers are common to separate events. Advantageously, a pattern of commonality may result in information related to suspects or witnesses that may facilitate resolution of open events or unsolved crimes. Incident lists may also be advantageously provided to other jurisdictions for comparison in intrastate or interstate investigations.

FIG. 9 is a block diagram illustrating an exemplary wireless communication device 450 that may be used in connection with the various embodiments described herein. For example, the wireless communication device 450 may be used in conjunction with a handset, PDA, or mobile computer device or as a part of a computer system integrated into a automobile. However, other wireless communication devices and/or architectures may also be used, as will be clear to those skilled in the art.

In the illustrated embodiment, wireless communication device 450 comprises an antenna 452, a multiplexor 454, a low noise amplifier (“LNA”) 456, a power amplifier (“PA”) 458, a modulation circuit 460, a baseband processor 462, a speaker 464, a microphone 466, a central processing unit (“CPU”) 468, a data storage area 470, and a hardware interface 472. In the wireless communication device 450, radio frequency (“RF”) signals are transmitted and received by antenna 452. Multiplexor 454 acts as a switch, coupling antenna 452 between the transmit and receive signal paths. In the receive path, received RF signals are coupled from a multiplexor 454 to LNA 456. LNA 456 amplifies the received RF signal and couples the amplified signal to a demodulation portion of the modulation circuit 460.

Typically modulation circuit 460 will combine a demodulator and modulator in one integrated circuit (“IC”). The demodulator and modulator can also be separate components. The demodulator strips away the RF carrier signal leaving a base-band receive audio signal, which is sent from the demodulator output to the base-band processor 462.

If the base-band receive audio signal contains audio information, then base-band processor 462 decodes the signal and converts it to an analog signal. Then the signal is amplified and sent to the speaker 464. The base-band processor 462 also receives analog audio signals from the microphone 466. These analog audio signals are converted to digital signals and encoded by the base-band processor 462. The base-band processor 462 also codes the digital signals for transmission and generates a base-band transmit audio signal that is routed to the modulator portion of modulation circuit 460. The modulator mixes the base-band transmit audio signal with an RF carrier signal generating an RF transmit signal that is routed to the power amplifier 458. The power amplifier 458 amplifies the RF transmit signal and routes it to the multiplexor 454 where the signal is switched to the antenna port for transmission by antenna 452.

The baseband processor 462 is also communicatively coupled with the central processing unit 468. The central processing unit 468 has access to a data storage area 470. The central processing unit 468 is preferably configured to execute instructions (i.e., computer programs or software) that can be stored in the data storage area 470. Computer programs can also be received from the baseband processor 462 and stored in the data storage area 470 or executed upon receipt. Such computer programs, when executed, enable the wireless communication device 450 to perform the various functions of the present invention as previously described.

In this description, the term “computer readable medium” is used to refer to any media used to provide executable instructions (e.g., software and computer programs) to the wireless communication device 450 for execution by the central processing unit 468. Examples of these media include the data storage area 470, microphone 466 (via the baseband processor 462), antenna 452 (also via the baseband processor 462), and hardware interface 472. These computer readable mediums are means for providing executable code, programming instructions, and software to the wireless communication device 450. The executable code, programming instructions, and software, when executed by the central processing unit 468, preferably cause the central processing unit 468 to perform the inventive features and functions previously described herein.

The central processing unit is also preferably configured to receive notifications from the hardware interface 472 when new devices are detected by the hardware interface. Hardware interface 472 can be a combination electromechanical detector with controlling software that communicates with the CPU 468 and interacts with new devices.

FIG. 10 is a block diagram illustrating an exemplary computer system 550 that may be used in connection with the various embodiments described herein. For example, the computer system 550 may be used in conjunction with a remote wireless computer system, a precinct server, a computer system integrated into an automobile, or a laptop computer, just to name a few. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of communication means including wire or cable, fiber optics, conventional phone line, cellular phone link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

While the particular systems and methods herein shown and described in detail are fully capable of attaining the above described objects of this invention, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A computer implemented method for field checking a license plate number, comprising:
receiving a voice input from a user, the voice input comprising at least one license plate number;
converting the voice input to text;
parsing the text to obtain a license plate number;
querying a database to determine a vehicle status corresponding to the license plate number; and
providing the vehicle status to the user.

2. The method of claim 1, wherein the at least one license plate number in the voice input comprises a state designation and a unique identifier.

3. The method of claim 2, wherein the unique identifier is an alpha-numeric string.

4. The method of claim 1, wherein the providing step comprises presenting the vehicle status on a computer display.

5. The method of claim 1, wherein the vehicle status comprises a state designator, a license plate number, and a current status.

6. The method of claim 5, wherein the current status is stolen.

7. The method of claim 6, wherein an audio alert is sounded to indicate that the current status is stolen.

8. The method of claim 5, wherein the current status is warrant.

9. The method of claim 5, wherein the current status is missing person.

10. The method of claim 5, wherein the current status is clear.

11. The method of claim 1, wherein the database is accessed via a network.

12. A computer implemented method for creating an incident list, comprising:
receiving a voice input from a user, the voice input comprising at least one license plate number;
converting the voice input to text;
parsing the text to obtain a license plate number;
storing the license plate number in a data storage area; and
associating a plurality of stored license plate numbers with an incident number to create an incident list.

13. The method of claim 12, wherein the at least one license plate number in the voice input comprises a state designation and a unique identifier.

14. The method of claim 13, wherein the unique identifier is an alpha-numeric string.

15. The method of claim 12, wherein the incident list comprises a collection of license plate numbers for vehicles that were near a crime scene.

16. The method of claim 15, further comprising constructing a witness list based on the license plate numbers in the incident list.

17. The method of claim 12, further comprising uploading the incident list to a central server.

18. A computer implemented method for creating an incident list, comprising:
receiving a voice input from a user, the voice input comprising at least one license plate number;
converting the voice input to text;
parsing the text to obtain a license plate number;
obtaining current location information;
associating the license plate number with the current location;
storing the license plate number and current location in a data storage area; and
assigning a plurality of stored license plate numbers with an incident number to create an incident list.

19. The method of claim 18, wherein the current location information includes current time information.
